(19) United States
(12) Patent Application Publication
(10) Pub. No.: US 2014/0370898 A1
(43) Pub. Date: Dec. 18, 2014

(54) Admission Control

(71) Applicant: Mikko Saily, Laukkoski (FI)

(72) Inventor: Mikko Saily, Laukkoski (FI)

(21) Appl. No.: 14/373,657

(22) PCT Filed: Jan. 23, 2012
(86) PCT No.: PCT/EP2012/050967

§ 371 Date: Jul. 22, 2014

(51) Int. Cl. H04W 36/32; H04W 48/16

(52) U.S. Cl. CPC H04W 36/32; H04W 48/16
USPC 455/436

(57) ABSTRACT

The invention relates to an apparatus: including at least one processor and at least one memory including a computer program code, the at least one memory and the computer program code configured to, with the at least one processor, cause the apparatus at least to: obtain a handover request and information on mobility status of a handover user device, and carry out an admission control procedure, the admission control procedure including cell suitability evaluation based on the information on mobility status of the handover user device.

### FIELD

The invention relates to apparatuses, methods, systems, computer programs, computer program products and computer-readable media.

### BACKGROUND

The following description of background art may include insights, discoveries, understandings or disclosures, or associations together with disclosures not known to the relevant art prior to the present invention but provided by the invention. Some such contributions of the invention may be specifically pointed out below, whereas other such contributions of the invention will be apparent from their context.

Admission control (AC) is designed to grant or reject resource requests, such as requests for bearers. It usually takes into account resource status in a network. Quality-of-Service requirements of a requested resource, priority levels and/or Quality-of-Service of currently active sessions in the network, for instance.

### BRIEF DESCRIPTION

According to an aspect of the present invention, there is provided an apparatus comprising: at least one processor and at least one memory including a computer program code, the at least one memory and the computer program code configured to, with the at least one processor, cause the apparatus at least to: make a handover decision, and convey a handover request and information on mobility status of a handover user device to a target node.

According to an aspect of the present invention, there is provided an apparatus comprising: at least one processor and at least one memory including a computer program code, the at least one memory and the computer program code configured to, with the at least one processor, cause the apparatus at least to: obtain a handover request and information on mobility status of a handover user device, and carry out an admission control procedure, the admission control procedure comprising cell suitability evaluation based on the information on mobility status of the handover user device.

According to yet another aspect of the present invention, there is provided a method comprising: making a handover decision, and conveying a handover request and information on mobility status of a handover user device to a target node.

According to yet another aspect of the present invention, there is provided a method comprising: obtaining a handover request and information on mobility status of a handover user device, and carrying out an admission control procedure, the admission control procedure comprising cell suitability evaluation based on the information on mobility status of the handover user device.

According to yet another aspect of the present invention, there is provided an apparatus comprising: means for making a handover decision, and means for conveying a handover request and information on mobility status of a handover user device to a target node.

According to yet another aspect of the present invention, there is provided an apparatus comprising: means for obtaining a handover request and information on mobility status of a handover user device, and means for carrying out an admission control procedure, the admission control procedure comprising cell suitability evaluation based on the information on mobility status of the handover user device.

According to yet another aspect of the present invention, there is provided a computer program embodied on a computer-readable storage medium, the computer program comprising program code for controlling a process to execute a process, the process comprising: making a handover decision, and conveying a handover request and information on mobility status of a handover user device to a target node.

According to yet another aspect of the present invention, there is provided a computer program embodied on a computer-readable storage medium, the computer program comprising program code for controlling a process to execute a process, the process comprising: obtaining a handover request and information on mobility status of a handover user device, and carrying out an admission control procedure, the admission control procedure comprising cell suitability evaluation based on the information on mobility status of the handover user device.

### LIST OF DRAWINGS

Some embodiments of the present invention are described below, by way of example only, with reference to the accompanying drawings, in which

FIG. 1 illustrates examples of systems;

FIG. 2 is a flow chart,

FIG. 3 is another flow chart;

FIG. 4 illustrates examples of apparatuses, and

FIG. 5 illustrates other examples of apparatuses.

### DESCRIPTION OF SOME EMBODIMENTS

The following embodiments are only examples. Although the specification may refer to “an”, “one”, or “some” embodiment(s) in several locations, this does not necessarily mean that each such reference is to the same embodiment(s), or that the feature only applies to a single embodiment. Single features of different embodiments may also be combined to provide other embodiments.

Embodiments are applicable to any user device, such as a user terminal, as well as to any network element, relay node, server, node, corresponding component, and/or to any communication system or any combination of different communication systems that support required functionalities. The communication system may be a wireless communication system or a communication system utilizing both fixed networks and wireless networks. The protocols used, the specifications of communication systems, apparatuses, such as servers and user terminals, especially in wireless communication, develop rapidly. Such development may require extra changes to an embodiment. Therefore, all words and expressions should be interpreted broadly and they are intended to illustrate, not to restrict, embodiments.

In the following, different exemplifying embodiments will be described using, as an example of an access architecture to which the embodiments may be applied, a radio access architecture based on long term evolution (LTE), that is based on orthogonal frequency multiplexed access (OFDMA) in a downlink and a single-carrier frequency-division multiple access (SC-FDMA) in an uplink, without restricting the embodiments to such an architecture, however. It is obvious for a person skilled in the art that the embodiments may also be applied to other kinds of communications networks having suitable means by adjusting parameters and procedures appropriately. Some examples of other options for suitable systems are the universal mobile telecommunications system (UMTS) radio access network (UTRAN or E-UTRAN), long term evolution advanced (LTE-A,), global system for mobile communication (GSM), wireless local area network (WLAN or WiFi), worldwide interoperability for microwave access (WiMAX). Bluetooth®, personal communications services (PCS). ZigBee®, wideband code division multiple access (WCDMA), systems using ultra-wideband (UWB) technology, sensor networks, and mobile ad-hoc networks (MANETs).

In an orthogonal frequency division multiplexing (OFDM) system, the available spectrum is divided into multiple orthogonal sub-carriers. In OFDM systems, the available bandwidth is divided into narrower sub-carriers and data is transmitted in parallel streams. Each OFDM symbol is a combination of signals on each of the subcarriers. Further, each OFDM symbol is preceded by a cyclic prefix (CP), which is used to decrease Inter-Symbol

Interference. Unlike in OFDM. SC-FDMA subcarriers are not independently modulated.

Typically, a (e)NodeB (“e” stands for evolved) needs to know channel quality of each user device and/or the preferred precoding matrices (and/or other multiple input-multiple output (MIMO) specific feedback information, such as channel quantization) over the allocated sub-bands to schedule downlink transmissions to user devices. Such required information is usually signalled to the (e)NodeB by using uplink signalling.

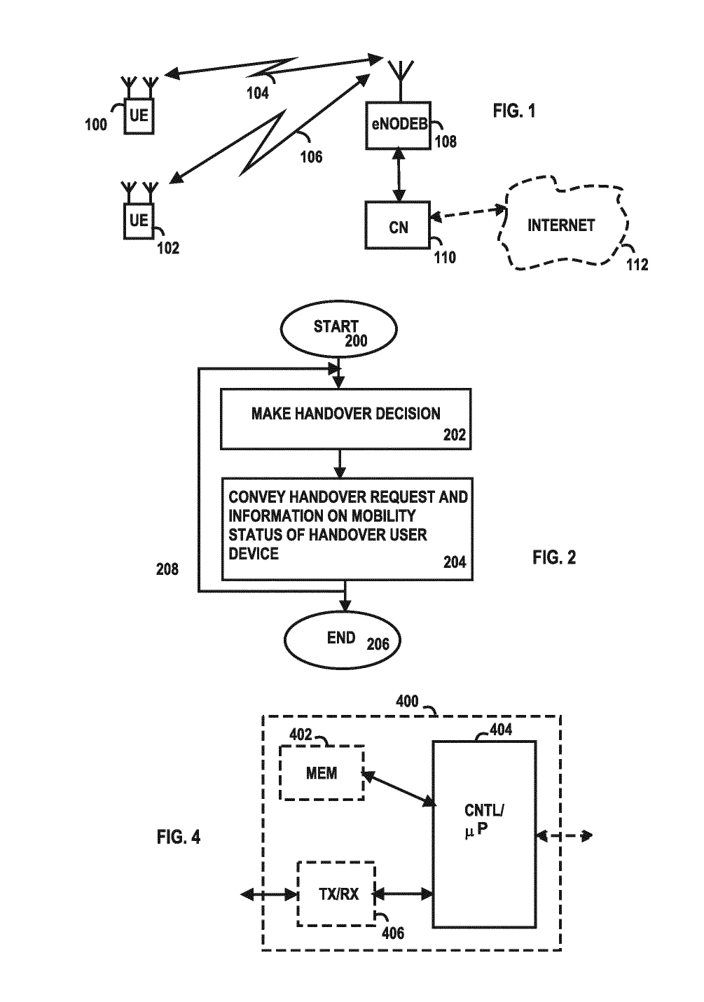

FIG. 1 depicts examples of simplified system architectures only showing some elements and functional entities, all being logical units, whose implementation may differ from what is shown. The connections shown in FIG. 1 are logical connections; the actual physical connections may be different. It is apparent to a person skilled in the art that the system typically comprises also other functions and structures than those shown in FIG. 1.

The embodiments are not, however, restricted to the system given as an example but a person skilled in the art may apply the solution to other communication systems provided with necessary properties.

FIG. 1 shows a part of a radio access network based on E-UTRA. LTE, or LTE-Advanced (LTE-A).

FIG. 1 shows user devices 100 and 102 configured to be in a wireless connection on one or more communication channels 104 and 106 in a cell with a (e)NodeB 108 providing the cell. The physical link from a user device to a (e)NodeB is called uplink or reverse link and the physical link from the NodeB to the user device is called downlink or forward link.

The NodeB, or advanced evolved node B (eNodeB, eNB) in LTE-Advanced, is a computing device configured to control the radio resources of communication system it is coupled to. The (e)NodeB may also be referred to as a base station, an access point or any other type of interfacing device including a relay station capable of operating in a wireless environment.

The (e)NodeB includes transceivers, for example. From the transceivers of the (e)NodeB, a connection is provided to an antenna unit that establishes bi-directional radio links to user devices. The antenna unit may comprise a plurality of antennas or antenna elements. The (e)NodeB is further connected to core network 110 (CN). Depending on the system, the counterpart on the CN side can be a serving gateway (S-GW, routing and forwarding user data packets), packet data network gateway (P-GW), for providing connectivity of user devices (UEs) to external packet data networks, or mobile management entity (MME), etc.

A communications system typically comprises more than one (e)NodeB in which case the (e)NodeBs may also be configured to communicate with one another over links, wired or wireless, designed for the purpose. These links may be used for signalling purposes.

The communication system is also able to communicate with other networks, such as a public switched telephone network or the Internet 112. The communication network may also be able to support the usage of cloud services. It should be appreciated that (e)NodeBs or their functionalities may be implemented by using any node, host, server or access point etc. entity suitable for such a usage.

The user device (also called UE, user equipment, user terminal, terminal device, etc.) illustrates one type of an apparatus to which resources on the air interface are allocated and assigned, and thus any feature described herein with a user device may be implemented with a corresponding apparatus, such as a relay node. An example of such a relay node is a layer 3 relay (self-backhauling relay) towards the base station.

The user device typically refers to a portable computing device that includes wireless mobile communication devices operating with or without a subscriber identification module (SIM), including, but not limited to, the following types of devices: a mobile station (mobile phone), smartphone, personal digital assistant (PDA), plug-in data modem (such as a universal serial bus. USB, stick), handset, device using a wireless modem (alarm or measurement device, etc.), laptop and/or touch screen computer, tablet, game console, notebook, and multimedia device.

The user device (or in some embodiments a layer 3 relay node) is configured to perform one or more of user equipment functionalities. The user device may also be called a subscriber unit, mobile station, remote terminal, access terminal, user terminal or user equipment (UE) just to mention but a few names or apparatuses.

It should be understood that, in FIG. 1, user devices are depicted to include 2 antennas only for the sake of clarity. The number of reception and/or transmission antennas may naturally vary according to a current implementation.

Further, although the apparatuses have been depicted as single entities, different units, processors and/or memory units (not all shown in FIG. 1) may be implemented.

It is obvious for a person skilled in the art that the depicted system is only an example of a part of a radio access system and in practise, the system may comprise a plurality of (e)NodeBs, the user device may have an access to a plurality of radio cells and the system may comprise also other apparatuses, such as physical layer relay nodes or other network elements, etc. At least one of the NodeBs or eNodeBs may be a Home(e)nodeB. Additionally, in a geographical area of a radio communication system a plurality of different kinds of radio cells as well as a plurality of radio cells may be provided. Radio cells may be macro cells (or umbrella cells) which are large cells, usually having a diameter of up to tens of kilometres, or smaller cells such as micro-, femto- or picocells. The (e)NodeBs of FIG. 1 may provide any kind of these cells. A cellular radio system may be implemented as a multilayer network including several kinds of cells and some of the cells may belong to different radio access technology layers. Typically, in multilayer networks, one node B provides one kind of a cell or cells, and thus a plurality of (e) Node Bs are required to provide such a network structure.

Recently for fulfilling the need for improving the deployment and performance of communication systems, the concept of “plug-and-play” (e)Node Bs has been introduced. Typically, a network which is able to use “plug-and-play” (e)Node (e)Bs, may include, in addition to Home (e)Node Bs (H(e)nodeBs), a home node B gateway, or HNB-GW (not shown in FIG. 1). A HNB Gateway (HNB-GW), which is typically installed within an operator's network may aggregate traffic from a large number of HNBs back to a core network.

Heterogenenous networks “HetNets” are means for expanding mobile network capacity. A heterogeneous network typically comprises devices using multiple radio access technologies, architectures, transmission solutions, etc. The heterogeneous networks may also create challenges due to the deployment of different wireless nodes such as macro/micro (e)NBs, pico (e)NBs, and Home (e)NBs creating a multi-layer network using a same spectrum resource. Usually, centralized network planning and optimization is not well-suited to the individualistic nature of user-deployed cells, such as femtocells. Thus cooperation between nodes in a decentralized and distributed manner may be provided. Cooperative heterogeneous networks are also known as “coHetNets”.

Cognitive and re-configurable radios may be a key for obtaining a heterogeneous communication environment where mitigation techniques and cognitive signalling are used for sharing the spectrum and routing information. Spectrum sharing or flexible spectrum usage between different layers or cells of a same radio access network (RAN), between different RANs of a same operator, between different operators, etc., is recognized as a promising method to enhance the usage of available frequency domain resources. One of the basic sources for spectrum sharing gain is provided by large variations of traffic offered to a cell.

Cognitive radios are designed to efficient spectrum use deploying so-called smart wireless devices being capable to sense and detect the environment and adapt to it thus being suitable for opportunistic spectrum usage, in which also the frequency bands not being used by their primary (usually licensed) users may be utilized by secondary users. For this purpose cognitive radios are designed to detect unused spectrum, such as spectrum holes. Alternatively, network may store information about spectrum resources that are available for a secondary usage. The information on spectrum resources may be combined with geo-location of a device, and thus available spectrum resources for the device in this particular location may be defined.

In the following, some embodiments are disclosed in further details in relation to FIG. 2. Embodiments are related to admission control (AC) and mobility in multi-layer cellular systems which may also be referred to as heterogeneous networks. In this context, multi-layer network may refer to a network wherein a both macro base stations or nodes as well as small power base stations such as pico and micro base stations or nodes are deployed as a part of a same operator cellular network. Macro-layer and pico/micro layer may even be implemented in different radio access technologies (RATs).

Multi-layer LTE networks may be deployed using one of the following two configurations or a combination thereof: both a macro node and small nodes are using the same carrier (known as co-channel deployment or intra-frequency deployment), and a macro node and small nodes are using different carrier frequencies (known as dedicate carrier deployment or inter-frequency deployment). For both scenarios, in evolved packet system, bearers in a cell are granted or rejected. In this process admission control may take into account resource status in a network, Quality-of Service requirements of a requested resource, priority levels and/or Quality-of-Service of currently active sessions in the network, for instance. That is to say, a new resource request may be granted, if QoS for a new resource, such as a bearer, can be fulfilled while maintaining on-going services for other users.

If a user is moving clearly faster than pedestrian velocities, a fast moving user device is usually preferred to camp at a macro layer due to problems in mobility performance. However, if a connected mode user device is handed into a small cell, it may occur that the small cell needs to share its resources among large number of connections potentially degrading both peak rate and average data rate of existing users. Even when one fast moving user camps in a small cell for only a short period of time, statistically-speaking, a continuous load may be created by user devices entering and leaving the cell.

An embodiment starts in block 200. The embodiment may be carried out by a handover source node, host or server.

In block 202, a handover decision is made.

In a cellular communication system, a hand-over may take place, when a user device moves between two cells. In an exemplary handover process, as described in a simplified manner, a source node, based on measurement reports obtained from the user device, determines that, for example, Quality-of-Service is too low or a risk for a connection failure exists, and inquires of a possible target node whether it has enough resources for the user device. If the target node can accommodate the user device, it prepares radio resources before the source cell commands the user device to handover to the target cell.

In block 204, handover request and information on mobility status of a handover user device is conveyed to a target node.

A mobility status of a handover user device may be obtained from the handover user device in advance or as a part of the handover process. It may be based on user device's history Information (IE) gathered by a node and comprising information about cells the user device has been served by in an active state prior to the intended target cell. This is described in the 3GPP 36.413, which is taken herein as a reference as to the user equipment (UE) history information IE. In the history information, cell type information usually provides a cell coverage area, as enumerated (verysmall, small, medium, large, etc.), for example. Thus, the mobility status may be determined based on a cell type. For instance, if the current cell type is “verysmall”, it is quite obvious that a fast moving user device is not going to stay in this cell for a long time. Other usable information may be a list of previous cells, such as “Last Visited Cell List”, which may give statistical information, such as the number of visited cells (for instance, if a user device has visited a plurality of cells in a short period of time, it is quite probable that it will act in the same way in the close future). Similar deductions may be made on the basis of information on time spent in one or more previous cells. Additionally, the history information may be based on number of past handovers and/or cell reselections. Mobility status may also be based on a metric derived from measurements made for cells being discovered.

It should be appreciated that mobility status information may be estimated by a user device, a network or both. In the case the user device carries out the estimation, the information may be obtained and delivered to a network either during a call setup or with measurement signalling. The mobility status may be estimated from idle mode and/or connected mode state.

Typically, a source node provides information about a user devices mobility status to a target node. The information may be added to a “source node to target node transparent container”.

Additionally, each node in a network may collect statistics usable in estimating the frequency of user device's handovers, such as radio link failures, handover failures or ping-pongs.

The embodiment ends in block 206. The embodiment is repeatable in many ways. One example is shown by arrow 208 in FIG. 2.

Another embodiment starts in block 300. The embodiment may be carried out by a handover target node, host or server.

In block 302, handover request and information on mobility status of a handover user device is obtained.

The information on mobility status of the handover user device may be received with the handover request or it may be obtained in a separate message, for example.

A mobility status of a handover user device may be obtained from the handover user device in advance or as a part of the handover process. It may be based on user device's history Information (IE) gathered by a node and comprising information about cells that the user device has been served by in an active state prior to the intended target cell. This is described in the 3GPP 36.413, which is taken herein as a reference as to the UE history information IE. In the history information, cell type information usually provides a cell coverage area as enumerated (verysmall, small, medium, large, etc.), for example. Thus, the mobility status may be determined based on a cell type. For instance, if the current cell type is “verysmall”, it is quite obvious that a fast moving user device is not going to stay in this cell for a long time. Other usable information may be a list of previous cells, such as “Last Visited Cell List”, which may give statistical information, such as the number of visited cells (for instance, if a user device has visited a plurality of cells in a short period of time, it is quite probable that it will act in the same way in the close future). Similar deductions may be made on the basis of information on time spent in one or more previous cells. Additionally, the history information may be based on number of past handovers and/or cell reselections.

It should be appreciated that the mobility status information may be estimated by a user device, a network or both. A user device may estimate and report its mobility status to a network either during a call setup or with measurement signalling. The mobility status may be estimated from idle mode and/or connected mode state.

Typically, a source node provides information about a user device's mobility status to a target node. The information may be added to a “source node to target node transparent container”.

Additionally, each node in a network may collect statistics usable in estimating the frequency of user device's handovers, such as radio link failures, handover failures or ping-pongs.

A target node may collect user device's history information as long as the user device stays in one of its cells, and store the collected information for being available for future handover preparations.

In block 304, admission control procedure is carried out. The admission control procedure comprises cell suitability evaluation based on the information on the mobility status of the handover user device.

The admission control herein may be considered to be “enhanced” by cell suitability evaluation.

The admission control procedure is typically carried out in a target node for deciding whether to grant or reject an access request based on, for example, at least one of: load, requested Quality-of-Service and guaranteed bit rate. If the conditions are fulfilled, for example the requested Quality-of-Service can be provided, cell suitability evaluation may be carried out. The suitability evaluation may comprise deciding on the suitability of a target cell type and/or size with a user device's mobility status, that is to say the user device's mobility is suitable for the size of the target cell, or the user device's mobility is suitable for the cell type (such as “verysmall”, see above), for example.

If a handover request is accepted, a target node may send a handover request acknowledgment message to a source node and the source node proceeds with a handover command.

If a handover request is rejected, a target node may send a handover preparation failure message to a source node with information indicating admission rejection due to unsuitable user device mobility status. Correspondingly, if a target node does not admit at least one bearer, the target node may send a handover preparation failure message to a source node with information indicating admission rejection due to unsuitable user device mobility status.

A target node may thus identify unsuitable mobility status and reject a handover to one of its cells already at a handover preparation phase. Hence, no need for further handover execution signalling or resource allocation in the target node for a short stay user device exists.

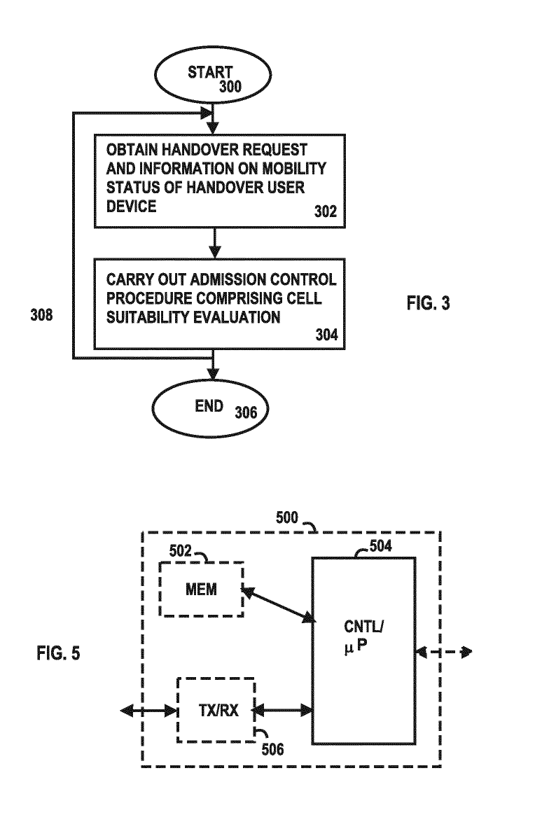

The embodiment ends in block 306. The embodiment is repeatable in many ways. One example is shown by arrow 308 in FIG. 3.

It should be understood that macro cells may be considered to be stable in providing sufficient coverage. Therefore, if the admission control procedure described above when carried out in a small cell rejects the unsuitable handover, potential macro cells to accept the handover are likely to be found. This provides a possibility to control the load in a cell caused by high mobility users with a short time of stay.

An “escape” mechanism into a small power cell may be implemented, wherein a handover request rejection due to unsuitable mobility status is overruled by a high priority handover request. In this case, the target cell admission control procedure disclosed above is turned off for a particular handover request.

Solving interference problems by a handover or cell reselection especially for fast moving users may not be fast enough. In these cases, the admission control procedure described above may be fast enough by rejecting unsuitable handovers before they have been completed. It may also reduce the number of ping-pongs.

The steps/points, signaling messages and related functions described above in FIGS. 2 and 3 are in no absolute chronological order, and some of the steps/points may be performed simultaneously or in an order differing from the given one. Other functions may also be executed between the steps/points or within the steps/points and other signaling messages sent between the illustrated messages. Some of the steps/points or part of the steps/points can also be left out or replaced by a corresponding step/point or part of the step/point.

It should be understood that conveying, transmitting and/or receiving may herein mean preparing a data conveyance, transmission and/or reception, preparing a message to be conveyed, transmitted and/or received, or physical transmission and/or reception itself, etc. on a case by case basis. The same principle may be applied to terms transmission and reception as well.

An embodiment provides an apparatus which may be any user device, relay node, node, host, webstick or server any other suitable apparatus capable to carry out processes described above in relation to FIG. 2.

FIG. 4 illustrates a simplified block diagram of an apparatus according to an embodiment.

As an example of an apparatus according to an embodiment, it is shown apparatus 400, including facilities in control unit 404 (including one or more processors, for example) to carry out functions of embodiments according to FIG. 2. The facilities may be software, hardware or combinations thereof as described in further detail below.

Another example of apparatus 400 may include at least one processor 404 and at least one memory 402 including a computer program code, the at least one memory and the computer program code configured to, with the at least one processor, cause the apparatus at least to: make a handover decision, and convey a handover request and information on mobility status of a handover user device to a target node.

Yet another example of an apparatus comprises means 404 for making a handover decision, and means 404 (406) for conveying a handover request and information on mobility status of a handover user device to a target node.

Yet another example of an apparatus comprises a decision unit configured to make a handover decision, and a conveying unit configured to convey a handover request and information on mobility status of a handover user device to a target node.

It should be understood that the apparatuses may include or be coupled to other units or modules etc., such as those used in or for transmission and/or reception. This is depicted in FIG. 4 as optional block 406. In FIG. 4, block 406 includes parts/units/modules needed for reception and transmission, usually called a radio front end. RF-parts, radio parts, radio head, etc.

Although the apparatuses have been depicted as one entity in FIG. 4, different modules and memory may be implemented in one or more physical or logical entities.

An embodiment provides an apparatus which may be any user device, relay node, node, host, webstick or server any other suitable apparatus capable to carry out processes described above in relation to FIG. 3.

FIG. 5 illustrates a simplified block diagram of an apparatus according to an embodiment.

As an example of an apparatus according to an embodiment, it is shown apparatus 500, including facilities in control unit 504 (including one or more processors, for example) to carry out functions of embodiments according to FIG. 3. The facilities may be software, hardware or combinations thereof as described in further detail below.

Another example of apparatus 500 may include at least one processor 504 and at least one memory 502 including a computer program code, the at least one memory and the computer program code configured to, with the at least one processor, cause the apparatus at least to: obtain a handover request and information on mobility status of a handover user device, and carry out an admission control procedure, the admission control procedure comprising cell suitability evaluation based on the information on mobility status of the handover user device.

Yet another example of an apparatus comprises means 504 (506) for obtaining a handover request and information on mobility status of a handover user device, and means 504 for carrying out an admission control procedure, the admission control procedure comprising cell suitability evaluation based on the information on mobility status of the handover user device.

Yet another example of an apparatus comprises an obtainer configured to obtain a handover request and information on mobility status of a handover user device, and a controller configured to carry out an admission control procedure, the admission control procedure comprising cell suitability evaluation based on the information on mobility status of the handover user device.

It should be understood that the apparatuses may include or be coupled to other units or modules etc., such as those used in or for transmission and/or reception. This is depicted in FIG. 5 as optional block 506. In FIG. 5, block 506 includes parts/units/modules needed for reception and transmission, usually called a radio front end, RF-parts, radio parts, radio head, etc.

Although the apparatuses have been depicted as one entity in FIG. 5, different modules and memory may be implemented in one or more physical or logical entities.

An apparatus may in general include at least one processor, controller or a unit designed for carrying out control functions operably coupled to at least one memory unit and to various interfaces. Further, the memory units may include volatile and/or non-volatile memory. The memory unit may store computer program code and/or operating systems, information, data, content or the like for the processor to perform operations according to embodiments. Each of the memory units may be a random access memory, hard drive, etc. The memory units may be at least partly removable and/or detachably operationally coupled to the apparatus. The memory may be of any type suitable for the current technical environment and it may be implemented using any suitable data storage technology, such as semiconductor-based technology, flash memory, magnetic and/or optical memory devices. The memory may be fixed or removable.

The apparatus may be at least one software application, module, or unit configured as arithmetic operation, or as a program (including an added or updated software routine), executed by at least one operation processor. Programs, also called program products or computer programs, including software routines, applets and macros, may be stored in any apparatus-readable data storage medium and they include program instructions to perform particular tasks. Computer programs may be coded by a programming language, which may be a high-level programming language, such as objective-C, C. C++, C#, Java, etc., or a low-level programming language, such as a machine language, or an assembler.

Modifications and configurations required for implementing functionality of an embodiment may be performed as routines, which may be implemented as added or updated software routines, application circuits (ASIC) and/or programmable circuits. Further, software routines may be downloaded into an apparatus. The apparatus, such as a node device, or a corresponding component, may be configured as a computer or a microprocessor, such as single-chip computer element, or as a chipset, including at least a memory for providing storage capacity used for arithmetic operation and an operation processor for executing the arithmetic operation.

Embodiments provide computer programs embodied on a distribution medium, comprising program instructions which, when loaded into electronic apparatuses, constitute the apparatuses as explained above. The distribution medium may be a non-transitory medium.

Other embodiments provide computer programs embodied on a computer readable storage medium, configured to control a processor to perform embodiments of the methods described above. The computer readable storage medium may be a non-transitory medium.

The computer program may be in source code form, object code form, or in some intermediate form, and it may be stored in some sort of carrier, distribution medium, or computer readable medium, which may be any entity or device capable of carrying the program. Such carriers include a record medium, computer memory, read-only memory, photoelectrical and/or electrical carrier signal, telecommunications signal, and software distribution package, for example. Depending on the processing power needed, the computer program may be executed in a single electronic digital computer or it may be distributed amongst a number of computers. The computer readable medium or computer readable storage medium may be a non-transitory medium.

The techniques described herein may be implemented by various means. For example, these techniques may be implemented in hardware (one or more devices), firmware (one or more devices), software (one or more modules), or combinations thereof. For a hardware implementation, the apparatus may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, digitally enhanced circuits, other electronic units designed to perform the functions described herein, or a combination thereof. For firmware or software, the implementation may be carried out through modules of at least one chip set (e.g., procedures, functions, and so on) that perform the functions described herein. The software codes may be stored in a memory unit and executed by processors. The memory unit may be implemented within the processor or externally to the processor. In the latter case it may be communicatively coupled to the processor via various means, as is known in the art. Additionally, the components of systems described herein may be rearranged and/or complimented by additional components in order to facilitate achieving the various aspects, etc., described with regard thereto, and they are not limited to the precise configurations set forth in the given figures, as will be appreciated by one skilled in the art.

It will be obvious to a person skilled in the art that, as technology advances, the inventive concept may be implemented in various ways. The invention and its embodiments are not limited to the examples described above but may vary within the scope of the claims.

1. An apparatus comprising:
at least one processor and at least one memory including a computer program code, the at least one memory and the computer program code configured to, with the at least one processor, cause the apparatus at least to:
make a handover decision, and
convey a handover request and information on mobility status of a handover user device to a target node.

2. An apparatus comprising:
at least one processor and at least one memory including a computer program code, the at least one memory and the computer program code configured to, with the at least one processor, cause the apparatus at least to:
obtain a handover request and information on mobility status of a handover user device, and
carry out an admission control procedure, the admission control procedure comprising cell suitability evaluation based on the information on mobility status of the handover user device.

3. The apparatus of claim 1, wherein the information on mobility status of the handover user device is obtained from the handover user device.

4. The apparatus of claim 1, wherein the information on mobility status of the handover user device is obtained during a call setup or with measurement signalling.

5. The apparatus of claim 1, wherein the information on mobility status of the handover user device is based on user device's history Information (IE) gathered by a node comprising information about cells that the handover user device has been served by in an active state.

6. The apparatus of claim 1, wherein the information on mobility status of the handover user device is determined based on at least one of the following: cell type information, a list of previous cells, information on time spent in one or more previous cells, a number of past handovers, metric derived from measurements made for cells being discovered, and a number of cell reselections.

7. The apparatus of claim 1, wherein the information on mobility status of the handover user device is added to a “source node to target node transparent container”.

8. The apparatus of claim 1, further comprising causing the apparatus to:
collect statistics usable in estimating the frequency of user device's handovers.

9. The apparatus of claims 2, wherein the cell suitability evaluation comprises deciding on suitability of a target cell type and/or size with the user device's mobility status.

10. The apparatus of claim 2, further comprising causing the apparatus to:
convey a handover request acknowledgment message to a source node, if a handover request is accepted, and
convey a handover preparation failure message to a source node with information indicating admission rejection due to unsuitable user device mobility status, if a handover request or at least one bearer is rejected.

11. (canceled)

12. (canceled)

13. (canceled)

14. A method comprising:
making a handover decision, and
conveying a handover request and information on mobility status of a handover user device to a target node.

15. A method comprising:
obtaining a handover request and information on mobility status of a handover user device, and carrying out an admission control procedure, the admission control procedure comprising cell suitability evaluation based on the information on mobility status of the handover user device.

16. The method of claim 14, wherein the information on mobility status of the handover user device is obtained from the handover user device.

17. The method of claim 14, wherein the information on mobility status of the handover user device is obtained during a call setup or with measurement signalling.

18. The method of claim 15, wherein the information on mobility status of the handover user device is based on user device's history Information (IE) gathered by a node comprising which comprises information about cells that the handover user device has been served by in an active state.

19. The method of claim 15, wherein the information on mobility status of the handover user device is determined based on at least one of the following: cell type information, a list of previous cells, information on time spent in one or more previous cells, a number of past handovers, metric derived from measurements made for cells being discovered, and a number of cell reselections.

20. The method of claim 15, wherein the information on mobility status of the handover user device is added to a “source node to target node transparent container”.

21. The method of claim 15, further comprising: collecting statistics usable in estimating the frequency of user device's handovers.

22. The method of claims 15, wherein the cell suitability evaluation comprises deciding on suitability of a target cell type and/or size with the user device's mobility status.

23. The method of claim 15, further comprising:
conveying a handover request acknowledgment message to a source node, if a handover request is accepted, and
conveying a handover preparation failure message to a source node with information indicating admission rejection due to unsuitable user device mobility status, if a handover request or at least one bearer is rejected.

24. (canceled)

25. (canceled)

26. (canceled)

27. (canceled)

28. The apparatus of claim 2, wherein the information on mobility status of the handover user device is obtained from the handover user device and wherein the information on mobility status of the handover user device is obtained during a call setup or with measurement signalling.

29. The method of claim 15, wherein the information on mobility status of the handover user device is obtained from the handover user device and wherein the information on mobility status of the handover user device is obtained during a call setup or with measurement signalling.
